(19) United States
(12) Patent Application Publication
(10) Pub. No.: US 2012/0025625 A1
(43) Pub. Date: Feb. 2, 2012

(54) SYSTEM AND INSTALLATION FOR TRANSFERRING ELECTRICAL ENERGY WITHOUT CONTACT

(75) Inventor: Marcel Jufer, Morges (CH)

(73) Assignee: NUMEXIA SA, Echallens (CH)

(21) Appl. No.: 13/148,411

(22) PCT Filed: Feb. 20, 2009
(86) PCT No.: PCT/IB2009/000311

§ 371 Date: Oct. 13, 2011

(51) Int. Cl. H02J 17/00

(52) U.S. Cl. 307/104

(57) ABSTRACT

A contact-free inductive power transfer system for minimizing the radiating magnetic field in the vicinity of the transmission zone. The system includes a primary coil (9) of n₁ turns and a secondary coil (10) of n₂ turns. In operation, the same volume of current is circulated in the primary and in the secondary coil during transfer and the number of turns n₁ in the primary coil multiplied by the current circulating in the primary coil is equal to the number of turns n₂ in the secondary coil multiplied by the current circulating in the secondary coil, the currents circulating in the primary and secondary coil being in phase opposition so as to minimize the radiating magnetic field generated by the coils. An installation for energizing a movable vehicle (14) through an intermediate loading station (6) is also described.

The present invention relates generally to a system for transferring electrical energy without contact by induction and to an installation comprising such a system of transfer for loading battery equipped electrical vehicles. More specifically, the invention relates to an inductive contact-free electric power transmission system through an air gap between a primary coil located on or in the ground and a secondary coil usually located on the lower part of a movable vehicle. While inductive coupling without contact and without ferro-magnetic circuit in between the primary and secondary circuits has been known since a long time, there are still unsolved problems when transfer of energy occurs at certain power levels, for example levels suitable to load battery operated public or private vehicles (between 10 kW and 500 KW). One of the unsolved and specific problem relates to the magnetic field radiation generated by the electromagnetic coupling between the primary coil and the secondary coil. None of the prior art document related to contact-free transfer of energy systems address this specific problem. However there exists, amongst others, a European directive specifying the maximum of intensity of a radiating magnetic field admitted specifically for the people working or standing in an exposed environment. This also apply to users of a public transportation system in which the vehicles use contact-free transmission of energy to be energized.

It is therefore the aim of the present invention to solve this problem by providing a contact-free energy transmission system and installation allowing to reduce drastically the magnetic field surrounding the transmission zone, while maintaining a transmission efficiency>95% in the range of a power suitable to operate public or private vehicles. This goal is achieved by a contact-free inductive power transmission system having the characteristics recited in claim 1.

Other features and advantages of the present invention will become apparent from the reading of the following detailed description of preferred embodiments made with reference to the annexed drawings in which:

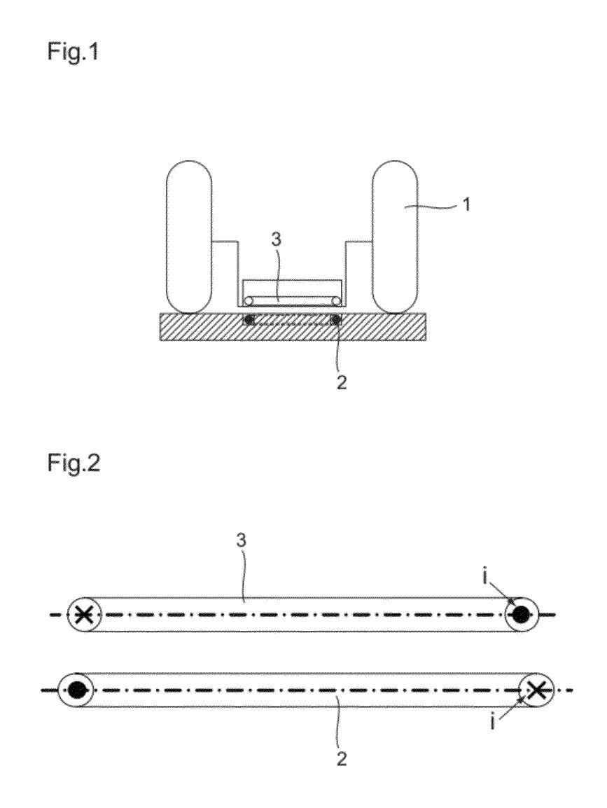

FIGS. 1 and 2 are schematic views illustrating the contact-free transmission of electrical energy.

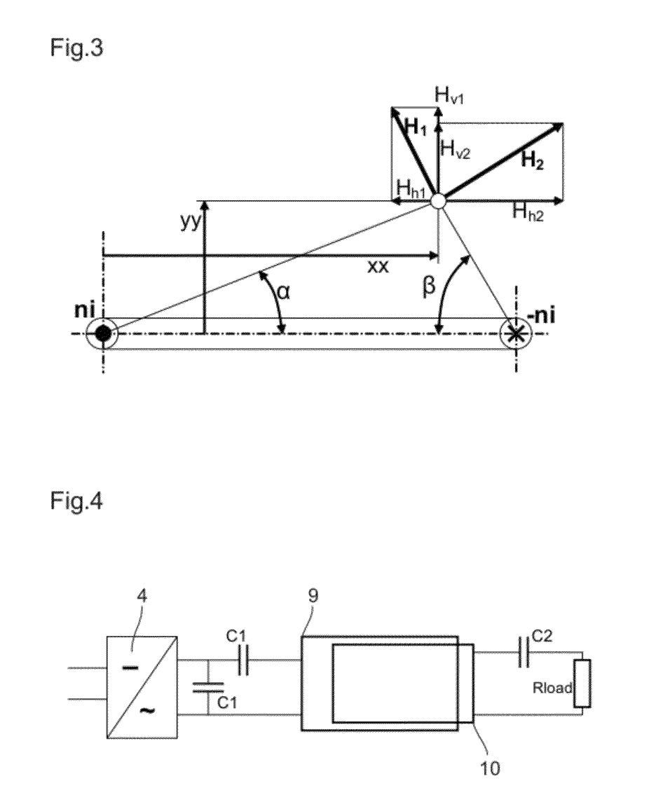

FIG. 3 is graphical representation for calculating the radiating magnetic field emitted by and electrical current circulating in a coil.

FIG. 4 shows the electrical circuit of a system according to the present invention.

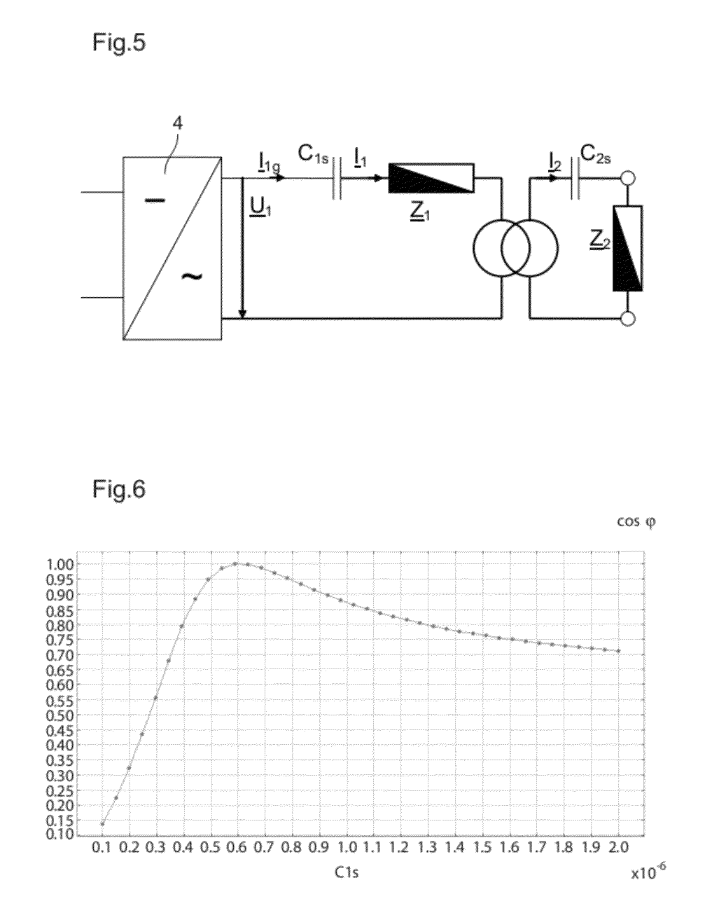

FIG. 5 represents the equivalent circuit of a system according to the present invention.

FIG. 6 is a graph showing the influence of the primary serial capacitor C1s on the power factor cow for a constant frequency.

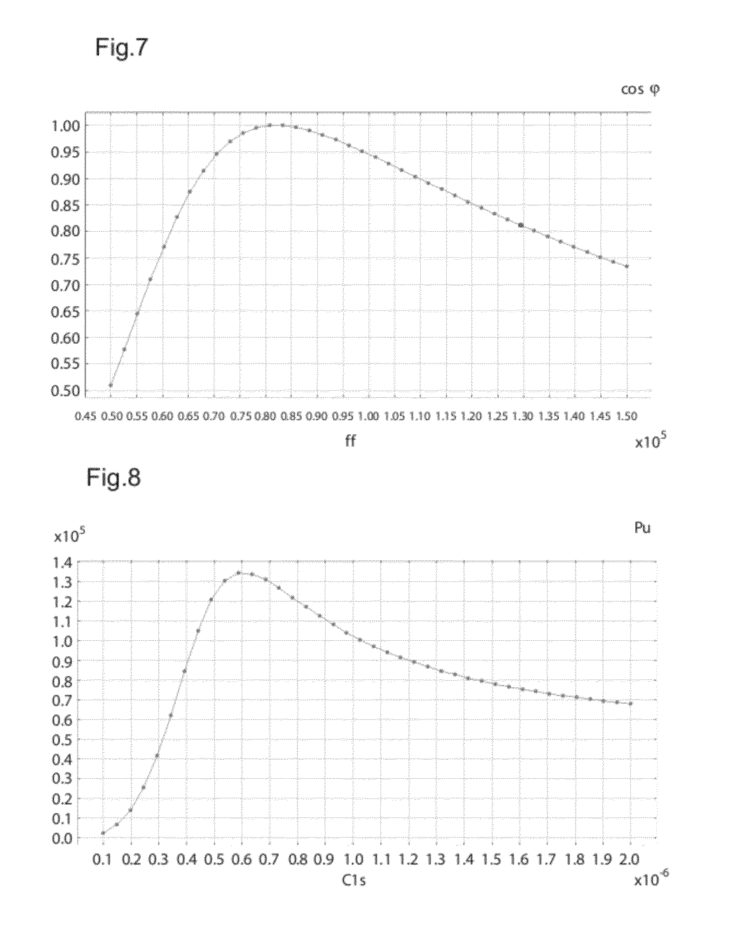

FIG. 7 is a graph showing the influence of the frequency ff on the power factor cow.

FIG. 8 is a graph showing the influence of primary serial capacitor C1s on the transmitted power Pu.

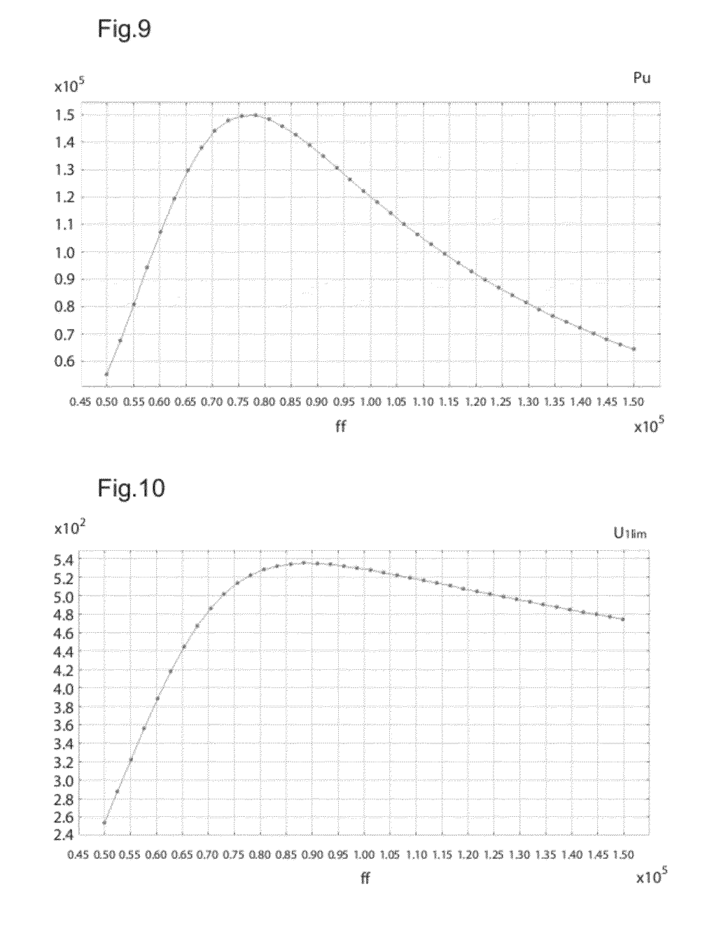

FIG. 9 is a graph showing the influence of the frequency ff on the transmitted power Pu.

FIG. 10 is a graph showing the influence of the frequency ff on the limit tension U₁ₗᵢₘ in order to reach a power factor of 1.

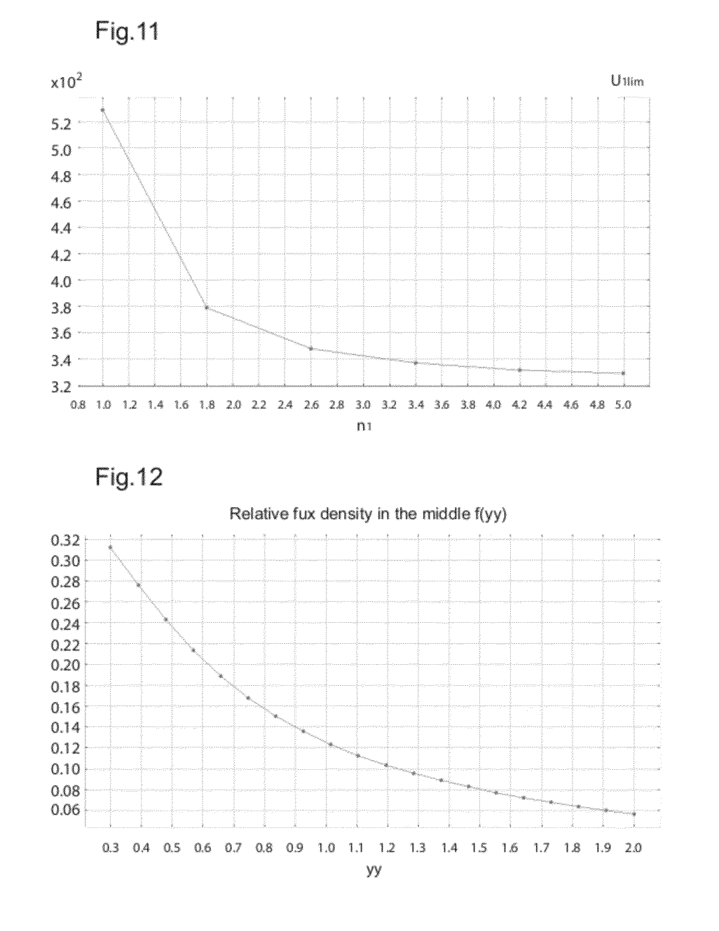

FIG. 11 is a graph illustrating the influence of the number of turns n₁ of the primary coil on the limit tension U1lim so as to reach a power factor of 1.

FIG. 12 is a graph shows the relative total flux density amplitude created by both coils in the middle of the coils from 0.3 m to 2 m.

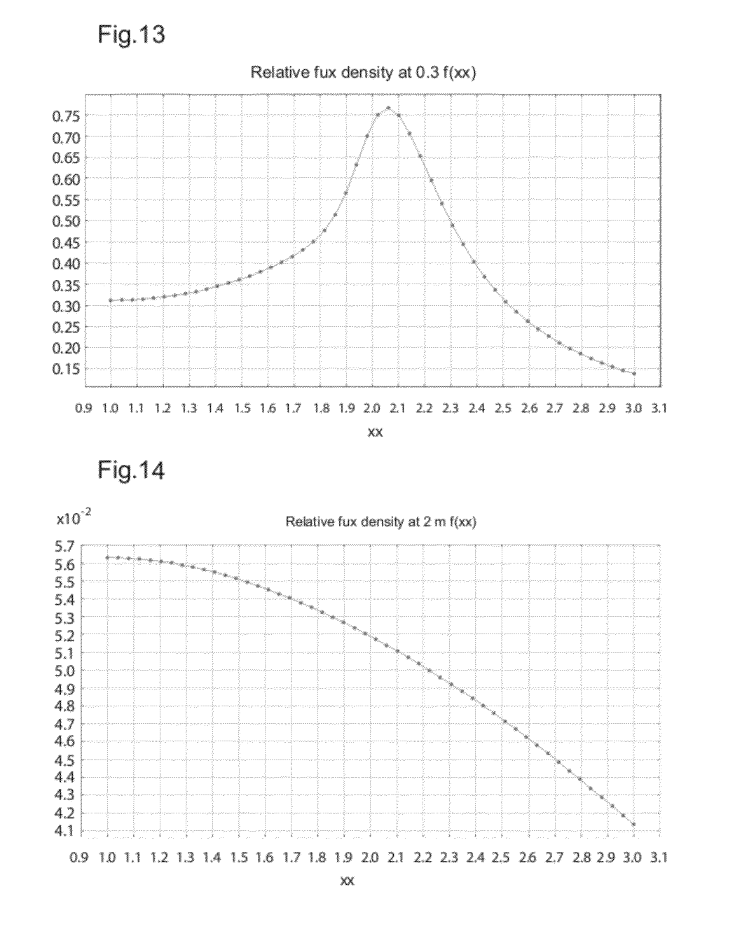

FIG. 13 is a graph showing the relative total flux density amplitude created by both coils at the floor level (0.3 m) from the middle of the coils corresponding to the middle of the vehicle (xx=1 m) to 1 m outside the vehicle (xx=3 m).

FIG. 14 is a graph showing the relative total flux density created by both coils is represented at a 2 meters level from the ground, from the middle of the coils (xx=1 m) to 1 meter outside of the vehicle (xx=3 m).

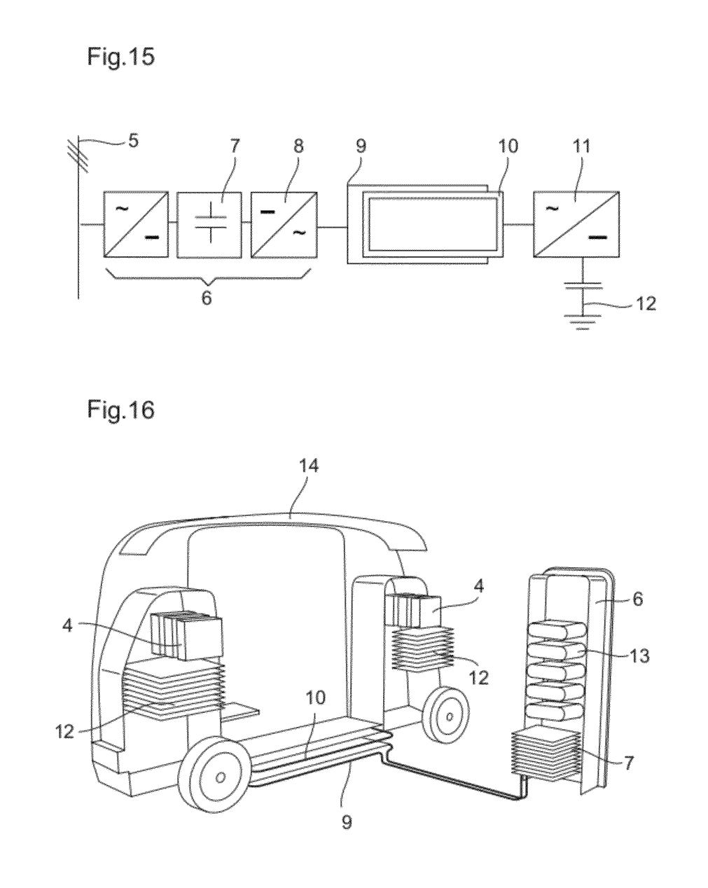

FIG. 15 represents schematically the system components of an installation with a contact free transfer system and a loading station.

FIG. 16 shows the loading station energizing a contact-free energy transfer system and a vehicle.

The principle of contact free energy transfer is represented schematically on FIGS. 1 and 2 in which the wheels 1 of a vehicle are laying on the ground. A m primary coil 2 is located in the ground. Note however that the primary coil 2 could also be lying on the ground. A secondary coil 3 is carried by the lower part of a vehicle (not represented). Such a contact-free energy transfer system is based on two coaxial coils 2,3 in the air or in any non-conductive material of permeability p0 placed at a relatively short distance (usually from 0.1 m to 0.3 m) and supplied with a high frequency voltage from 1 to 200 kHz according to the power to be transferred. Both coils 2,3 when alimented are supporting a current, generating a magnetic field all around.

The magnetic field determination is based on the superposition principle applied to the two conductors of the coil. As an hypothesis, a long coil in the direction perpendicular to the plan of FIG. 3 will be considered. This figure allows determining the magnetic field generated by a current i circulating in a coil of n turns at any point of coordinates xx,yy. (outside the Conductors). The magnetic field at a point of coordinate (xx,yy) created by a long coil is determined according to the following relations:

$${H}_{1} = \frac{ni}{2 π {r}_{1}}$$

with

r₁=\sqrt{xx²+yy²}

This field can be broken down into 2 components, a vertical and a horizontal component Hᵥ₁ and Hₕ₁ where:

$${H}_{v 1} = \frac{ni}{2 π {r}_{1}} cos α and {H}_{h 1} = - \frac{ni}{2 π {r}_{1}} sin α$$

$$cos α = xx / {r}_{1} sin α = yy / {r}_{1}$$

$${H}_{v 1} = \frac{ni}{2 π} \frac{xx}{{xx}^{2} + {yy}^{2}}$$

$${H}_{h 1} = \frac{- ni}{2 π} \frac{yy}{{xx}^{2} + {yy}^{2}}$$

Similarly, the field generated by the right part of the coil is:

$${H}_{v 2} = \frac{ni}{2 π} \frac{l - xx}{{( l - xx )}^{2} + {yy}^{2}}$$

$${H}_{h 2} = \frac{ni}{2 π} \frac{yy}{{( l - xx )}^{2} + {yy}^{2}}$$

The field amplitude in (xx,yy) is given by

H=\sqrt{(Hᵥ₁+Hᵥ₂)²+(Hₕ₁+Hₕ₂)²}

and the corresponding flux density is: B=μ₀H
These expressions are applicable for any point outside the copper coil.
With 2 coils, the superposition principle is applicable.
The Lentz' law defines the induced current as creating a field opposed to the cause. This means that the instantaneous current induced in the secondary coil is approximately in the opposite direction of the primary current. Consequently, the minimum of magnetic field is obtained when both currents are in phase opposition and if: n₁I₁≅n₂I₂ where n₁ is the number of turns of the primary coil and n₂ the number of turns of the secondary coil.
These conditions depend on the coil internal area, the number of turns, the power transferred, the frequency and the voltage, but also of the electrical scheme. Referring now to FIGS. 4 and 5, where FIG. 4 illustrates the electrical circuit and FIG. 5 the equivalent circuit allowing the reduction of the magnetic filed surrounding the transmission zone. The left side of the figures represents the alternative power source 4 alimenting the primary coil 9. U₁ is the tension at the primary and I1 the current circulating in the primary coil, Z₁ represents the impedance of the primary circuit and C1s is a capacitor mounted in serial with the primary. On the right of the FIG. 5, the electrical equivalent circuit of the secondary is shown with Z₂ representing the impedance of the secondary, and I2 the current circulating in the secondary. A serial capacitor C2s is also mounted in serial with the secondary circuit.

Having, as an example, imposed frequency, coil area, power and distance between the primary and secondary coils, it is possible to find a solution with a minimum of magnetic field by carefully dimensioning the two serial capacitors C1s and C2s as well as the number of turns in the primary coil and in the secondary coil.

As previously said, in order to obtain a minimum of the radiating magnetic field, the objective is to have the same volume of current circulating in the primary and in the secondary coils 9,10, and in phase opposition and where n₁I₁≅n₂I₂. This can only be achieved if a relation between the primary tension, the frequency and the number of turns in the primary coil as well the power transferred is fulfilled. This relation is determined expressing the value of the equivalent load secondary resistance allowing to reach exactly the required power; it is given below using the following definitions:

f=operating frequency
n₁, n₂=number of turns of the primary and secondary coils
L₁₂=mutual inductance between the primary and the secondary
Λ₁₂=mutual permeance between the primary and the secondary
Pu=useful power at the secondary
The mutual inductance L₁₂=n₁n₂Λ₁₂
The limit primary voltage U₁ₗᵢₘ allowing that the currents i₁ at the primary and i₂ at the secondary i₂ are in phase opposition is given by the following equation:

$${U}_{1 lim} = \sqrt{\frac{2 π {fL}_{12} {N}_{1} {P}_{u}}{2 {N}_{2}}} = \sqrt{2 π {fn}_{1}^{2} {Λ}_{12} {P}_{u}}$$

The condition to be fulfilled is that U₁ the primary tension alimenting the primary coil is lower or equal to U₁ₗᵢₘ as given above.
Therefore, considering that the power to be transferred is determined by the type of application and that the operating frequency is usually fixed by the source alimenting the primary coil, it is possible to determine the value of the number of turns, and the value of the two serial capacitor C1s and C2s respectively at the primary and at the secondary as well as the primary tension to deliver in order to fulfill the above mentioned requirement. It is to be noted that an optional parallel capacitor may be provided at the primary but is usually only optional as the power factor cosφ seen from the primary is generally almost equal to 1. However, as the number of turns can obviously only be an integer, a parallel capacitor at the primary can be used in case of consumption of reactive power in order to avoid the later to be debited by the source. On the other hand, the two serial capacitors at the primary C1s and at the secondary C2s are essential because without them, the above condition cannot be fulfilled.
It is also to be noted that the above mentioned condition U₁<U₁ₗᵢₘ, cannot be fulfilled without correctly dimensioning the serial capacitor C1s at the primary. The serial capacitor C2s at the secondary is automatically fixed as it is used to cancel the reactive component of the inductance at the secondary, transforming the secondary into an equivalent resistance. This is however not the case for the primary serial capacitor C1s as it not sufficient for the system to be simply resonant, this is clearly where reside the heart of this invention as it could have appeared obvious to use a resonant system. The condition of having the same volume of current in the primary and the secondary and currents in phase opposition cannot be fulfilled at resonance condition because it is the power factor (cosφ) as a whole seen from the source that should be considered. It is not sufficient to compensate the inductance at the primary with the primary serial capacitor C1s, but the mutual inductance must also be compensated. This cannot be achieved if the primary tension U₁ is not inferior to U₁ₗᵢₘ as defined above. The optimal serial capacitor C1s at the primary also depends of the number of turns n₂ at the secondary and of the leak reactance at the primary and the secondary. In order to minimize costs, the number of turns n₁ and n₂ in the primary and secondary coil are tried to be kept at a minimum.
FIGS. 6 to 11, illustrte the sensitivity to certain conception parameters. FIG. 6 shows the influence of the serial capacitor C1s at the primary on the power factor for a constant frequency.
FIG. 7 shows the effect of the frequency on the power factor. FIG. 8 illustrates the influence of the primary serial capacitor Cis on the transmitted power Pu.
FIG. 9 shows the influence of the frequency ff on the power transmitted Pu.
FIG. 10 shows the influence of the frequency ff on the limit tension U₁ₗᵢₘ in order to reach a power factor of 1, and lastly FIG. 11 illustrate the influence of the number of turns n₁ on the limit tension U₁ₗᵢₘ in order to reach a power factor of 1. To illustrate the above-depicted condition (i.e. impose the same current volume in the primary and secondary coils, the currents being in phase opposition), and demonstrate the magnetic filed radiation reduction, a prototype was build with the following parameters
Power transferred: 108 kW
Coil size rectangular: length 4 m*width 2 m
Distance between the primary and secondary coil d 0.115 m
Primary voltage: 500 V
Floor level above primary coil: 0.3 m

### Frequency: 100 kHz

Primary capacitor C1s: 0.435 pF
Secondary capacitor C2 0.928 pF
Primary power factor: 1.0
Primary number of turns n₁ 1
Secondary number of turns n₂ 1
Primary current 217 A
Secondary current 167 A
At FIG. 12, the relative total flux density amplitude created by both coils (primary and secondary) is represented in the middle of the coils from 0.3 m (floor) to 2 m (head). It is given on the vertical axis as a relative value, reported to the earth peak flux density (50 pT). The maximum relative value at the floor level is 0.31 m (15.2) μT and 0.06 (3 μT) at 2 m.
On FIG. 13, the relative total flux density amplitude created by both coils is represented at the floor level (0.3 m) from the middle of the coils corresponding to the middle of the vehicle (xx=1 m) to 1 m outside the vehicle (xx=3 m), reference is reported to the earth peak flux density (50 μT) on the ordinate. This graph shows that the maximum relative value at xx=2.05 m which is still under the vehicle is 0.77 equivalent to 38.5 μT and at xx=2.6 m corresponding to the waiting distance of the passengers, the value is 0.26 corresponding to 13 μT.
On the FIG. 14, the relative total flux density created by both coils is represented at a 2 meters level from the ground, from the middle of the coils (xx=1 m) to 1 meter outside of the vehicle (xx=3 m), the reference being the same, the peak earth magnetic flux density: 50 μT. In the latter case, the peak value of flux density is 0.056 (2.8 μT) in the middle of the coils and is of 0.0046 (2.3 μT) at 2.6 m corresponding to the waiting distance of the passengers. According to the European directive 2004/40/04 of THE EUROPEAN PARLIAMENT AND OF THE COUNCIL of 29 Apr. 2004 dealing with the minimum health and safety requirements regarding the exposure of workers to the risks arising from physical agents (electromagnetic fields), the limit value of the flux density is of around 20 μT for frequencies between 65 kHz and 100 kz. This value is only exceeded in a zone at around yy=0.3 m and xx=2.05 that are still under the vehicle and therefore easy to shield with conventional means like for example a thin perforated lamination on the floor of the vehicle which can practically suppress any field in the vehicle itself. The issue is on the lateral lower parts of the vehicle where same physical protections are problematic because they create eddy current losses. Thanks to the system of power transfer depicted above, it is no longer necessary to protect these zones' as the radiant magnetic field remains in acceptable limits in these zones. Furthermore, it is to be noted that avoiding lateral protections either on the vehicle itself or near the loading zone also reduce the costs of the whole installation.
According to another aspect of the invention, it will now be disclosed an installation using the system for transferring energy previously described. The main possibilities to store energy on electrical vehicles are chemical batteries and super-capacitors. Using chemical batteries the transfer time from main power supply to the vehicle through a rectifier is generally long (in the range of hours). On super-capacitors however, the same time can be very short in the range of seconds.
For a given amount of transferred energy Wst, the corresponding average power Ptr is equal to: Ptr=Wst/Ttr where Ttr is the transfer time.
Using super-capacitors, the power can be very high.
As an example for a 2 Ton vehicle with an autonomy of around 1 km, the necessary energy is in the range of 1 MJ and the corresponding power is 100 kW for a transfer time of 10 s.
The fast loading operation requires an important power peak on the main power supply which is not desirable. The following installation offers the possibility to smooth such a transfer with very limited power amplitude on the main power supply generally connected to the common supply network.
To that extent, the solution is to use an intermediate energy storage facility at the loading station, also based on super-capacitors. This loading station is energized with a constant limited power from the main supply. As an example, if a vehicle is loaded in 10 seconds every 2 minutes, the average power removed from the main power supply is only 8.33 kW.
Using a contact free power transmission system as disclosed removes the necessity to connect the vehicle at the loading station, allowing therefore a very short time to reload the vehicle. Loading stations may be installed at different locations corresponding to bus stop in case of a public transportation system for example. FIG. 15 represents schematically the system components to implement such a solution. The left of FIG. 15 shows the main power supply 5 connected to the storage station 6 which comprises a bank of super capacitors 7 as well as a high frequency generator 8 alimenting a fixed coil 9 in or above the ground. This fixed coil corresponds to the primary coil described in relation with the energy transfer system previously disclosed. The right of the figure illustrates the components installed in the vehicle. The vehicle is equipped with a coil 10 acting as the secondary coil connected to a rectifier 11, itself connected to one or more bank of super capacitors 12 installed in the vehicle. Referring now to FIG. 16, an example of the whole installation is represented with the loading station 6 comprising the power electronic components 13 for controlling the whole process, the bank of super capacitors 7 used to store temporally energy and the connection to the primary coil 9. The vehicle 14 is also equipped with the necessary power electronic components 4 for driving the process and at least on bank of super cacitors 12. The secondary coil 10 is located under the floor of the vehicle 14. Preferably, the propulsion of the vehicle is achieved with wheel motors. As previously disclosed, the radiating magnetic filed is kept to a minimum thanks the system of energy transfer in the loading zone. It is also to be noted that the primary coil 9 is only energized during the loading of the vehicle's super capacitor. The same principle can also been applied to battery loading with fast loading possibility. The power peaks on the main supply are considerably reduced thanks to such an installation while preserving a short loading time.

1. A contact-free inductive power transfer system for minimizing the radiating magnetic field in the vicinity of the transmission zone of two coaxial coils (9,10) comprising a primary coil (9) of n₁ turns and a secondary coil (10) of n₂ turns characterized in that the same volume of current is circulated in the primary and in the secondary coil during transfer and in that the number of turns n₁ in the primary coil (9) multiplied by the current circulating in the primary coil is equal to the number of turns n₂ in the secondary coil (10) multiplied by the current circulating in the secondary coil, the currents circulating in the primary and secondary coil being in phase opposition.

2. A contact-free inductive power transfer system according to claim 1 characterized in that it comprises means connected to the primary coil (9) and to the secondary coil (10) for modifying the mutual inductance between the primary and the secondary coil.

3. A system according to claim 1 characterized in that the means for adapting the mutual inductance between the primary coil and the secondary coil are constituted of a serial capacitor C1s connected to the primary coil and a serial capacitor C2s connected to the secondary coil.

4. A system according to claim 1 characterized in that the primary tension U₁ alimenting the primary coil (9) is inferior to a value U₁ₗᵢₘ given by the following formula U_{1 lim}=\sqrt{2πfn₁²Λ₁₂Pᵤ} where
n₁=number of turns of the primary coil
Λ₁₂=mutual permeance between the primary and the secondary
f=frequency
Pᵤ=useful power at the secondary

5. A system according to claim 1 characterized in that the primary coil (9) is installed on or in the ground and in that the secondary coil (10) is located under a vehicle.

6. A system according to claim 1 characterized in that it is used to transfer useful power in the range of 10 kW to 500 kW at a frequency comprised between 1 and 200 kHz.

7. An installation for powering an electrical vehicle (14) thanks to a power transfer system according to claim 1 characterized in that it further comprises an intermediate loading station (6) having a bank of super capacitors (7) as well as a high frequency generator (8) for alimenting a primary coil (9) located in or above the ground and in that the secondary coil (10) is located under the floor of the vehicle (14) which also comprises at least one bank of super capacitors (12).
